(19) United States
(12) Patent Application Publication
(10) Pub. No.: US 2003/0212188 A1
(43) Pub. Date: Nov. 13, 2003

(54) Impermeable membrane based on flexible PVC for lining pools

(75) Inventor: Hans Tanghe, Oudenaarde (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 10/393,013

(22) Filed: Mar. 21, 2003

(30) Foreign Application Priority Data
Mar. 22, 2002 (FR) 02.03651

(51) Int. Cl. C08K 3/40

(52) U.S. Cl. 524/494

(57) ABSTRACT

Impermeable membrane for pools, based on flexible PVC containing a glass reinforcement; manufacturing process and use of such a membrane.

The present invention relates to an impermeable membrane for pools based on flexible PVC, to a process for manufacturing such a membrane and to its use as a lining for pools.

The use of flexible PVC as a lining material for pools has been known for a long time.

Thus, U.S. Pat. No. 5,191,007 discloses the use of a particular flexible PVC formulation for this purpose, having as feature a reduction in the chemical degradation of the lining just above the surface of the water.

The use of a membrane made of homogeneous (unreinforced) flexible PVC is an economic solution but it does have drawbacks:

the membrane must be produced in advance, in the form of a bag, and then has to be transported to the pool in order to be installed therein as a single piece, which may in some cases cause a problem (on account of the size and the geometry of the pool, its environment, etc.);

its dimensional stability is low and after water absorption the membrane swells, and wrinkles form in the lining.

To remedy these drawbacks, it has been conceived to provide the PVC membranes with a polyester reinforcement. This is because the presence of such a reinforcement makes it possible to produce welds (and therefore to assemble the lining) in situ. Furthermore, it gives the structure improved dimensional stability. Finally, although a flexible PVC lining does not by itself support any load (it simply hugs the wall after undergoing elongation caused by the weight of the water), a reinforced PVC lining may by itself support, at least in part (in certain regions), the load (weight of water) and may have satisfactory tensile elongation properties in these places (for example in the corners, where the lining is by design undersized so as to obtain an integrated expansion joint). The polyester thus constitutes a material of choice for the reinforcement, on account of its tensile elongation properties. However, the use of a polyester reinforcement has the following drawbacks:

it is expensive; and

it complicates the recycling processes used at the present time; this is because polyester fibres are both flexible and strong, and therefore, unless they are cryogenically ground, cause problems during mechanical recycling processes (entanglements and blockages at certain points in the plants).

The object of the invention is consequently to provide a lining material for pools which is inexpensive, easy to recycle and resistant to wrinkle formation.

For this purpose, the invention relates to an impermeable membrane for pools, which is based on flexible PVC and includes a glass reinforcement.

It is based on the surprising observation that, although glass reinforcements are known for their poor tensile elongation properties, flexible PVC membranes provided with a glass reinforcement may benefit from an elongation at break of greater than or equal to 20%, or indeed greater than 100% and in certain cases even greater than 200%.

The expression “impermeable membrane for lining pools” is understood according to the present invention to mean a membrane having all the characteristics (both technical and aesthetic) required for fulfilling its function (as an impermeable lining for pools), and does so possibly by means of a coat of paint, lacquer, etc. on one side and/or a layer of adhesive (or other aid to anchoring) on the other side. According to the present invention, the term “pool” denotes in fact any body of water (generally artificial) which can be contained by means of an impermeable lining; it may, for example, be a swimming pool (according to the conventional definition of the term), a lake, a garden pond, etc.

The term “flexible PVC” is understood according to the present invention to mean a compound based on at least one vinyl chloride resin (preferably a homopolymer, but possibly also a copolymer with monomers such as vinyl acetate in an amount of at most 50%) and on at least one plasticizer. The vinyl chloride resin according to the present invention may be obtained by suspension or emulsion polymerization. Preferably, it is a suspension resin. This resin advantageously has a Kw (or K-value, a characteristic of the viscosity of the resin) of greater than or equal to 60, or even 70, but preferably less than or equal to 80, or even 75. The plasticizer may be chosen from phthalates, adipates, sebacates and trimellitates. Preferably it may be a phthalate such as DIDP (diisodecyl phthalate), DEHP or DOP (di-2-ethylhexyl phthalate or diotyl phthalate) or a mixture of phthalic acid di esters and C₆-C₁₁ linear alcohols. Preferably, the flexible PVC comprises a vinyl chloride homopolymer with a K number (K-value) of between 60 and 80 and a phthalate as plasticizer. In general, it also includes additives such as stabilizers (for example based on Pb, Sn, Ca/Zn or Ba/Zn, etc.), antioxidants (epoxidized soybean oil (ESO), bisphenol A, phenolic derivatives, phosphites, etc.), pigments (for example TiO₂), fillers (for example CaCO₃), etc.

The membrane according to the present invention advantageously contains a fraction of waste, such as waste from the production of similar membranes or of other PVC articles, regrind of spent membranes or of other spent PVC articles, etc. Particularly preferably, it includes waste from the production of similar membranes and/or regrind of spent similar membranes. This is because, unlike the polyester reinforcements, the glass reinforcements break easily during recycling, thus giving an inert filler than can be used for the production of new membranes (all that is required is to adapt the composition in order to take account of this filler level). However, the degree of recycling is generally limited, especially to prevent contamination. Advantageously, and when this is possible taking into account the method of implementation chosen, recycled resin will mainly, or even exclusively, be used via the resin forming the hidden face of the lining (that face in contact with the walls of the pool).

The term “glass reinforcement” is understood according to the present invention to mean a plane reinforcement consisting of glass fibres.

According to a first preferred embodiment of the present invention, this is a glass mesh consisting of “woven” glass fibres, that is to say fibres arranged in two perpendicular directions, without necessarily being interlaced, preferably so that the distance between parallel yarns is greater than or equal to 1 mm. However, this distance is advantageously less than or equal to 1 cm. This mesh preferably consists of fibres, whose weight per 10000 m is greater than or equal to 280 g (i.e. fibres of 280 dtex or more) or even greater than or equal to 340 g (340 dtex or more). In general, they are fibres of 2200 dtex or less, preferably 1100 dtex or less, or even 550 dtex or less. The weight of these glass meshes (and therefore their thickness and their mesh density) is tailored to the desired mechanical and thermal strength. The term “mesh density” is understood to mean the number of yarns per cm in each of the perpendicular directions. In general, the mesh density used is greater than or equal to 1×1, preferably greater than or equal to 2×2. However, this mesh density is advantageously less than or equal to 10×10, or even 8×8. It should be noted in this regard that, for the same weight (that is to say the same dtex and the same mesh density), a glass reinforcement gives better results than a polyester reinforcement.

According to a second preferred embodiment of the present invention, a glass fleece is used as reinforcement, that is to say one in which the glass fibres are entangled, optionally agglomerated using a binder or provided with excrescences that help the fibres to catch on one another. Preferably, the fleece according to this embodiment of the present invention has a weight of greater than or equal to 10 g/m², or even greater than or equal to 50 g/m². However, its weight is generally less than or equal to 200 g/m², or even less than or equal to 100 g/m². The weight of this fleece is also tailored to the desired mechanical and thermal resistance.

The glass used in the present invention may be of any type. Preferably, it is a glass of the “E” type, that is to say a standard and inexpensive grade. However, special grades (A, B, etc.) may be used depending on the desired mechanical and/or chemical resistance.

Preferably, the membrane according to the present invention consists of two flexible PVC layers placed, at least partly (taking into account possible interpenetration), on either side of the glass reinforcement. In this way, the glass reinforcement is protected and its role as internal reinforcement is optimized. In general, the two outer layers of flexible PVC have the same or similar compositions (the latter case covering, for example, the abovementioned embodiment in which only one layer (the concealed face) contains production waste or spent membrane regrind).

The membrane according to the present invention may be manufactured by calendering/laminating (i.e. the two PVC layers are firstly formed by calendering and then they are placed on either side of the reinforcement by hot laminating), by extrusion-laminating (a similar process, but one in which the calendering is replaced by extrusion), by coating (with a flexible PVC solution coating the reinforcement, followed by evaporation of the solvent), etc. Preferably, the process for manufacturing the membranes according to the present invention includes at least one calendering step and at least one laminating step.

The thickness of the membrane according to the present invention is generally greater than or equal to 0.5 mm, or even greater than or equal to 1 mm. In general, it is less than or equal to 2 mm, or even less than or equal to 1.5 mm. The glass reinforcement generally has a thickness of greater than or equal to 0.02 mm, or even greater than or equal to 0.05 mm. However, this thickness is generally less than or equal to 0.3 mm, or even less than or equal to 0.1 mm. If this reinforcement includes a flexible PVC layer on each side, these layers generally have a thickness of greater than or equal to 0.2 mm, or even greater than or equal to 0.4 mm, but less than or equal to 1.1 mm, or even less than or equal to 0.7 mm. Preferably, these two layers have the same thickness.

The membrane according to the present invention is generally sold in the form of rolls of variable length and width. The length generally varies from 10 to 40 m and the width from 100 to 300 cm. The most common dimensions are a length of 25 m for a width of 165 or 205 cm.

The membrane according to the present invention is advantageously used as a lining for pools. To allow the swelling caused by the progressive adsorption of water without causing wrinkles to form, it is general practice to provide, when laying the said lining, a rounded part at the base of the walls of the pool so that a void forms between the membrane and the wall of the pool, serving as an expansion region. In general, care should be taken to ensure that the radius of this rounded part remains less than 15 cm, and preferably less than 10 cm, or even less than 5 cm, mainly for aesthetic reasons. In practice, the method generally starts with sheets taken from rolls of membrane of suitable shape and dimensions (depending on the shape and the dimensions of the pool, the available welding equipment, etc.), which are joined together by welding so as to obtain an impermeable lining. To do this, these sheets are in general firstly placed so as to obtain an overlap of their edges (generally by at least 2 cm, or even at least 5 cm, but generally no more than 10 cm), and these edges are then welded together. The welding may be carried out by any suitable technique. Hot-air welding is particularly suitable.

The present invention will be illustrated in a non-limiting manner by the following examples.

Membranes were produced from sheets based on PVC with a Kw of 71, on DIDP (65 phr or 65 parts by weight with respect to 100 parts of resin), on ESO (2 phr), on a Ba/Zn stabilizer (3 phr of IRGASTAB® BZ561 stabilizer) and on pigments (7 phr of TiO₂ and 0.5 phr of Cu phthalocyanine blue) and having a thickness of 0.75 mm. These sheets were placed on either side of the reinforcements described below, and the assembly was then laminated between a metal roll heated to 170° C. and a rubber-coated back-up roll.

These membranes were then tested in a pool under identical conditions, in which the temperature above which wrinkles appeared was measured. The result of these tests is given in the table below.

| | | Wrinkling temperature |
|---|---|---|
| Reinforcement type | Mesh density/fibre count | (° C.) |
| no reinforcement | — | 27 |
| polyester | 3 × 3/1100 dtex | 32 |
| glass | 2 × 2/340 dtex | 32 |
| glass | 3 × 3/1100 dtex | 40 |
| glass (fleece) | 50 g/m² | 40 |

It may be seen that:

for the same performance, a glass mesh lighter than a polyester mesh may be used, and this solution is from 10 to 20% less expensive;

the membranes according to the present invention are suitable for novel applications at higher temperature, such as baths used in kinesitherapy and physiotherapy.

1- Lining for pools, consisting essentially of an impermeable membrane based on flexible PVC containing a glass reinforcement.

2- Lining according to claim 1, wherein the impermeable membrane has an elongation at break of greater than 20%.

3- Lining according to claim 1, wherein the flexible PVC comprises a vinyl chloride homopolymer having a K value (Kw) of between 60 and 80 and a phthalate as plasticizer.

4- Lining according to claim 1, wherein the impermeable membrane includes waste from the production of similar membranes and/or regrind from spent similar membranes.

5- Lining according to claim 1, wherein the glass reinforcement is a mesh or a fleece.

6- Lining according to claim 1, wherein the reinforcement is a mesh comprising glass fibres of 280 to 2200 dtex, woven with a mesh density ranging from 1×1 to 10×10.

7- Lining according to claim 1, wherein the reinforcement is a glass fleece having a weight of 10 to 200 g/m².

8- Lining according to claim 1, wherein the impermeable membrane comprises two flexible PVC layers placed at least in part on either side of the reinforcement.

9- Lining according to the preceding claim, wherein only one of the two flexible PVC layers contains waste from the production of similar membranes and/or regrind from spent similar membranes.

10- Lining according to claim 1, wherein the impermeable membrane is manufactured by a process comprising at least one calendering step and at least one laminating step.

11- Use of a lining according to claim 1 as a lining for pools.
